(19) United States
(12) Patent Application Publication
(10) Pub. No.: US 2024/0305721 A1
(43) Pub. Date: Sep. 12, 2024

(54) PREDICTION SYSTEM, READING SYSTEM, NON-TRANSITORY COMPUTER READABLE MEDIUM, AND METHOD

(71) Applicant: FUJIFILM Business Innovation Corp., Tokyo (JP)

(72) Inventor: Kanae NAGASAWA, Kanagawa (JP)

(73) Assignee: FUJIFILM Business Innovation Corp., Tokyo (JP)

(21) Appl. No.: 18/363,484

(22) Filed: Aug. 1, 2023

(30) Foreign Application Priority Data
Mar. 9, 2023 (JP) 2023-036731

(51) Int. Cl. H04N 1/00

(52) U.S. Cl. CPC H04N 1/00068; H04N 1/00716

(57) ABSTRACT

A prediction system includes a processor configured to: perform a first prediction process for predicting a first completion time, at which reading of a document bundle will be completed, before the reading; and perform a second prediction process for predicting, after some of the document sheets are read, a second completion time, at which reading of the document bundle will be completed, on a basis of an amount of change in weight or thickness of the document bundle and relationship information indicating a relationship between the amount of change and a number of document sheets read by this time or time taken to read the some of the document sheets.

### CROSS-REFERENCE TO RELATED APPLICATIONS

This application is based on and claims priority under 35 USC 119 from Japanese Patent Application No. 2023-036731 filed Mar. 9, 2023.

### BACKGROUND

### (i) Technical Field

The present disclosure relates to a prediction system, a reading system, a non-transitory computer readable medium, and a method.

### (ii) Related Art

Japanese Unexamined Patent Application Publication No. 2019-114885 discloses an image processing apparatus that executes a job for converting images of document sheets into data and transmitting the data. The image processing apparatus includes a display that displays a screen for allowing a user to specify a transmission destination, calculation means for calculating estimated time taken to execute the job for each of a plurality of conditions whose setting values for the conversion of the images into the data are different from one another, display control means for displaying, on the display, the estimated time calculated for each of the plurality of conditions, and job execution control means for performing control such that the job is executed under a selected one of the plurality of conditions.

### SUMMARY

A prediction system including a processor is possible. The processor performs a prediction process for predicting a completion time, at which reading of a document bundle will be completed, before the reading.

When a completion time, at which reading of a document bundle will be completed, is predicted before the reading as in this prediction system, the completion time needs to be predicted on the basis of information obtained before document sheets are read. When only the number of document sheets included in a document bundle is estimated on the basis of weight or thickness of the document bundle before reading of the document bundle and a prediction process for predicting a completion time on the basis of the estimated number of document sheets, for example, the predicted completion time and an actual completion time might greatly differ from each other if the estimated number of document sheets included in the document bundle is different from an actual number of document sheets.

Aspects of non-limiting embodiments of the present disclosure relate to improvement of accuracy of predicting a completion time compared to when only a prediction process for predicting a completion time, at which reading of a document bundle will be completed, is performed before the reading.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a prediction system including a processor configured to: perform a first prediction process for predicting a first completion time, at which reading of a document bundle will be completed, before the reading; and perform a second prediction process for predicting, after some of the document sheets are read, a second completion time, at which reading of the document bundle will be completed, on a basis of an amount of change in weight or thickness of the document bundle and relationship information indicating a relationship between the amount of change and a number of document sheets read by this time or time taken to read the some of the document sheets.

### BRIEF DESCRIPTION OF THE DRAWINGS

An exemplary embodiment of the present disclosure will be described in detail based on the following figures, wherein:

FIG. 1 is a schematic diagram illustrating a reading system according to an exemplary embodiment;

FIG. 2 is a block diagram illustrating an example of the hardware configuration of the reading system including a prediction system according to the exemplary embodiment;

FIG. 3 is a block diagram illustrating an example of the functional configuration of the prediction system according to the exemplary embodiment; and

FIG. 4 is a flowchart illustrating an example of a prediction process performed by the prediction system according to the exemplary embodiment.

### DETAILED DESCRIPTION

An exemplary embodiment of the present disclosure will be described hereinafter on the basis of the drawings.

### Reading System 10

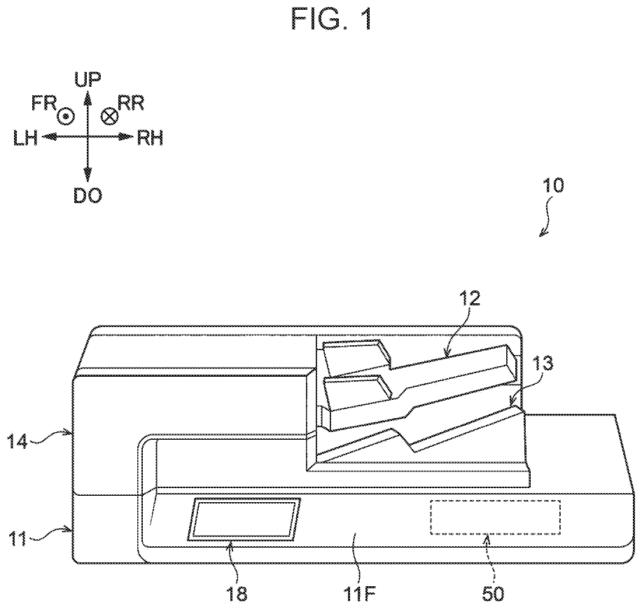

First, a reading system 10 according to the present exemplary embodiment will be described. FIG. 1 is a schematic diagram illustrating the reading system 10 according to the present exemplary embodiment.

An arrow UP in FIG. 1 indicates an upward direction (more specifically, a vertically upward direction) of an apparatus, and an arrow DO indicates a downward direction (more specifically, a vertically downward direction) of the apparatus. An arrow LH in FIG. 1 indicates a leftward direction of the apparatus, and an arrow RH indicates a rightward direction of the apparatus. An arrow FR in FIG. 1 indicates a forward direction of the apparatus, and an arrow RR indicates a rearward direction of the apparatus. These directions are defined for convenience of description, and the configuration of the apparatus is not limited by these directions. The term “apparatus” might be omitted when each direction of the apparatus is referred to. That is, the “upward direction of the apparatus”, for example, might be simply referred to as the “upward direction”.

The leftward and rightward directions in FIG. 1 can also be referred to a “side direction”, a “lateral direction”, or a “horizontal direction”. The forward and rearward directions in FIG. 1 can also be referred to as a “side direction”, a “lateral direction”, or a “horizontal direction”. The upward and downward directions, the leftward and rightward directions, and the forward and rearward directions intersect one another (more specifically, perpendicular to one another).

A symbol “×” inside a circle in FIG. 1 is an arrow points from the front of the paper to the back. A symbol “·” inside a circle in FIG. 1 is an arrow points from the back of the paper to the front.

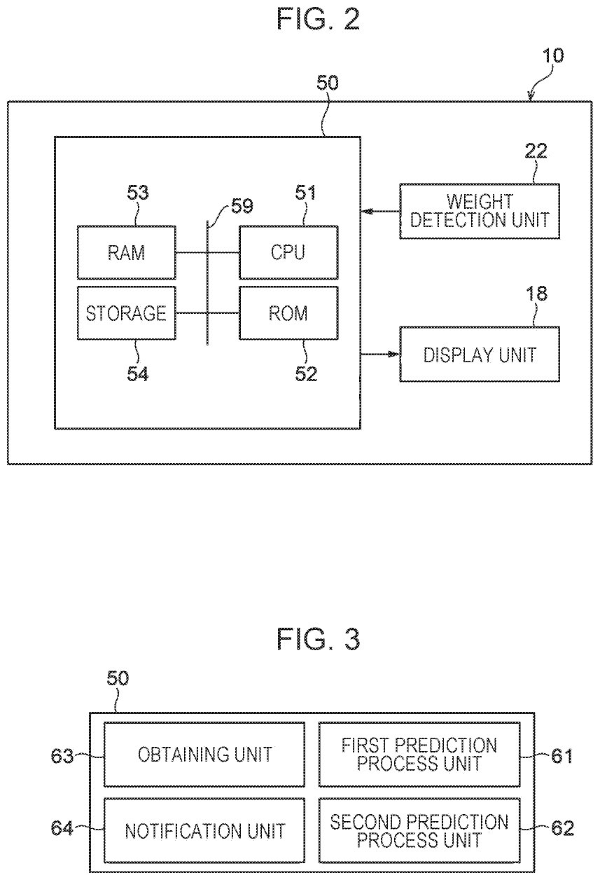

The reading system 10 illustrated in FIG. 1 reads images of document sheets. More specifically, as illustrated in FIG. 1, the reading system 10 includes an apparatus body 11, a document storage unit 12, a document discharge unit 13, a reading unit 14, a display unit 18, a weight detection unit 22 (refer to FIG. 2), and a prediction system 50. The components of the reading system 10 will be described hereinafter.

The reading system 10 may be applied to an image forming apparatus (e.g., a multifunction device) that reads images of document sheets and that forms images on a recording medium on the basis of the images.

### Apparatus Body 11

The apparatus body 11 illustrated in FIG. 1 is a part where the other components of the reading system 10 are provided. As illustrated in FIG. 1, the apparatus body 11 is a box-shaped housing where the other components of the reading system 10 are provided.

### Document Storage Unit 12

The document storage unit 12 illustrated in FIG. 1 is a component for storing document sheets. The document storage unit 12 stores, for example, a document bundle (a plurality of document sheets) stacked thereon. Each of the document sheets included in the document bundle stacked on the document storage unit 12 is supplied to the reading unit 14. The document sheets are, for example, sheets of paper.

### Document Discharge Unit 13

The document discharge unit 13 illustrated in FIG. 1 is a component to which document sheets are discharged. Document sheets whose images have been read by the reading unit 14 are discharged to the document discharge unit 13. In the present exemplary embodiment, the document discharge unit 13 is provided, for example, in the downward direction of the document storage unit 12.

### Reading Unit 14

The reading unit 14 illustrated in FIG. 1 is a component for reading each of document sheets included in a document bundle. In the present exemplary embodiment, the reading unit 14 is provided in the leftward direction of the document storage unit 12 and the document discharge unit 13.

More specifically, the reading unit 14 includes a reading device (not illustrated) and a conveying mechanism (not illustrated). The reading unit 14 reads an image of each of document sheets included in a document bundle stored in the document storage unit 12 using the reading device while conveying the document sheet using the conveying mechanism. As the reading device, an image sensor of a contact type, namely a contact image sensor (CIS), for example, is used.

### Display Unit 18

The display unit 18 illustrated in FIG. 1 is an example of a notification unit, and displays presentation information to be presented to a user to notify the user of the presentation information. The display unit 18 is, for example, a liquid crystal display or an organic electroluminescent (EL) display.

In the present exemplary embodiment, the display unit 18 is provided, for example, on a front surface 11F in the forward direction of the apparatus body 11. A user in front of the apparatus body 11, therefore, can see the display unit 18.

The display unit 18 also functions as an input unit for allowing the user to input commands. In this case, the input unit is a resistive or capacitive touch panel, for example, and the user inputs commands by touching the input unit.

The commands input by the user include a reading command to read each of document sheets included in a document bundle and a command to make reading settings for the reading. The reading settings include resolution of read images and a reading method (single-sided reading or double-sided reading).

The input unit is not limited to a touch panel, and may be input keys such as a keyboard or operation buttons or any other device that allows the user to input commands, instead.

### Weight Detection Unit 22

The weight detection unit 22 illustrated in FIG. 2 detects the weight of a document bundle stored in the document storage unit 12. The weight detection unit 22 is, for example, a weight sensor provided in a stacking surface of the document storage unit 12, on which a document bundle is stacked. Document bundle information indicating the weight of a document bundle detected by the weight detection unit 22 is transmitted to a central processing unit (CPU) 51, which will be described later.

### Prediction System 50

FIG. 2 is a block diagram illustrating an example of the hardware configuration of the reading system 10 including the prediction system 50 according to the present exemplary embodiment.

The prediction system 50 performs, for a document bundle stored in the document storage unit 12, a first prediction process for predicting, before the reading a first completion time, at which reading of the document bundle will be completed, and a second prediction process for predicting a second completion time, at which the reading of the document bundle will be completed, after some of document sheets included in the document bundle are read.

The prediction system 50 has functions as a computer and, as illustrated in FIG. 2, includes the CPU 51, a read-only memory (ROM) 52, a random-access memory (RAM) 53, and a storage 54. The CPU 51 is an example of a processor.

The CPU 51, the ROM 52, the RAM 53, and the storage 54 are connected to one another by a bus 59. The CPU 51 controls the entirety of the prediction system 50. The ROM 52 stores various programs and various pieces of data, for example, including a prediction program used in the present exemplary embodiment. The RAM 53 is a memory used as a work area when the various programs are executed. The CPU 51 performs various types of processing by loading the programs stored in the ROM 52 into the RAM 53 and executing the programs.

The storage 54 is a hard disk drive (HDD), a solid-state drive (SSD), or a flash memory, for example, and stores various programs, various pieces of data, and the like. The prediction program may be stored in the storage 54.

The CPU 51 of the prediction system 50 achieves the various functions of the reading system 10 by executing the prediction program. A functional configuration achieved by a cooperation between the CPU 51 as a hardware resource and the prediction program as a software resource will be described hereinafter. FIG. 3 is a block diagram illustrating an example of the functional configuration of the prediction system 50 according to the present exemplary embodiment.

As illustrated in FIG. 3, the prediction system 50 includes, for example, an obtaining unit 63, a first prediction process unit 61, a second prediction process unit 62, and a notification unit 64.

The obtaining unit 63 obtains a result of detection performed by the weight detection unit 22 (i.e., document bundle information indicating the weight of a document bundle stored in the document storage unit 12). The obtaining unit 63 also obtains past user information regarding the user.

The first prediction process unit 61 performs the first prediction process for predicting, before the reading, the first completion time, at which reading of a document bundle will be completed. More specifically, the first prediction process unit 61 estimates, before reading of a document bundle, the number of document sheets included in the document bundle on the basis of document bundle information indicating the weight of the document bundle and performs the first prediction process for predicting the first completion time on the basis of the number of document sheets.

If the obtaining unit 63 obtains past use information regarding the user, the first prediction process unit 61 also identifies a most frequently used type of document sheet on the basis of the past use information and estimates the number of document sheets included in the document bundle before the reading on the basis of the type of document sheet and the document bundle information.

If the obtaining unit 63 does not obtain past use information regarding the user, the first prediction process unit 61 estimates the number of document sheets included in the document bundle before the reading on the basis of a predetermined type of document sheet and the document bundle information.

The second prediction process unit 62 performs the second prediction process for predicting, after a predetermined number (hereinafter referred to as a “certain number”) of document sheets are read, the second completion time, at which reading of a document bundle will be completed, on the basis of the amount of change in the weight of the document bundle and relationship information indicating a relationship between the amount of change and the number of document sheets read by this time. The “certain number of document sheets” is an example of “some of document sheets”.

The second prediction process unit 62 also identifies, after the certain number of document sheets are read, a type of document sheet included in the document bundle on the basis of the amount of change in the weight of the document bundle and the relationship information indicating the relationship between the amount of change and the number of document sheets read by this time and holds information regarding the identified type of document sheet as part of the past use information regarding the user.

After the first prediction process is performed, the notification unit 64 notifies, before the reading of the certain number of document sheets is completed, the user of the first completion time and, after the second prediction process is performed, the user of the second completion time. The notification unit 64 also notifies a user terminal of at least the second completion time.

### Prediction Process According to Present Exemplary Embodiment

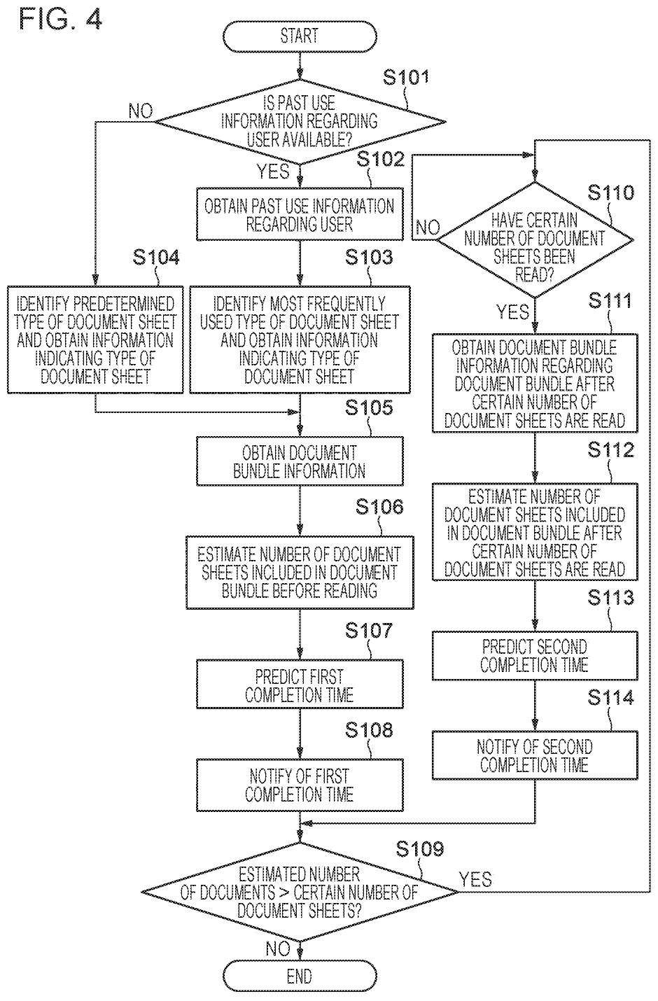

Next, an example of the prediction process according to the present exemplary embodiment will be described. FIG. 4 is a flowchart illustrating an example of the prediction process performed by the prediction system 50.

In the present exemplary embodiment, the CPU 51 performs the prediction process by loading the prediction program from the ROM 52 or the storage 54 and executing the prediction program. The prediction process starts, for example, when the CPU 51 obtains a reading command from the user.

As illustrated in FIG. 4, the CPU 51 starts the prediction process and determines whether past use information regarding a user is available (step S101).

More specifically, if there is past use information regarding a user after the user performs an operation for authenticating the user, for example, the CPU 51 determines that the past use information regarding the user is available. If the user does not perform the authentication operation, or if the user has performed the authentication operation but there is no past use information regarding the user, therefore, the CPU 51 determines that the past use information regarding the user is not available.

The user performs the authentication operation by, for example, holding an information medium (e.g., an identification card or a mobile terminal) storing identification (ID) information regarding the user onto a predetermined position of the apparatus body 11.

If determining that the past use information regarding the user is available (YES in step S101), the CPU 51 obtains the past use information regarding the user (step S102), identifies, as a type to be used for calculation, a most frequently used type of document sheet on the basis of the past use information, and obtains information (hereinafter referred to as “type information”) regarding the type of document sheet (step S103).

If determining that the past use information regarding the user is not available (NO in step S101), the CPU 51 identifies the predetermined type of document sheet as the type to be used for calculation and obtains type information regarding the type of document sheet (step S104).

The type to be used for calculation is a type of document sheet to be used to calculate, in step S106, which will be described later, the number of document sheets included in a document bundle stored in the document storage unit 12. The type information includes weight information for identifying a weight per document sheet. More specifically, the weight information is, for example, information indicating the size (i.e., area) of each document sheet and the weight of paper in grams per 1 square meter. In the information, the weight per document sheet is identified as “the weight of paper [g/m²]×the area of the document [m²]”. In the case of A4 size (210 mm×297 mm) and plain paper (weight: 70 g/m²), for example, the weight per document sheet is 70 [g/m²]×(0.210×0.297) [m²], that is, approximately 4.4 grams. The weight information may directly indicate the weight per document sheet, instead.

The CPU 51 then obtains document bundle information indicating the weight of the document bundle, stored in the document storage unit 12, before the reading (step S105). More specifically, the CPU 51 obtains document bundle information indicating the weight of the document bundle detected by the weight detection unit 22.

The CPU 51 then estimates the number of document sheets included in the document bundle before the reading on the basis of the type information and the document bundle information (step S106). More specifically, in step S106, the CPU 51 calculates the number of document sheets included in the document bundle before the reading as “the weight of the document bundle before the reading divided by the weight per document sheet” on the basis of the weight information included in the type information and the document bundle information.

The CPU 51 then performs the first prediction process for predicting, before the reading, the first completion time, at which the reading of the document bundle will be completed on the basis of the number of document sheets predicted in step S106 (hereinafter referred to as an “estimated number of document sheets”) (step S107). More specifically, the CPU 51 predicts the first completion time as “time taken to read each document sheet x the estimated number of document sheets”.

The time taken to read each document sheet can be obtained on the basis of performance of the reading unit 14 (e.g., document conveying speed) and the reading settings made by the user (e.g., resolution and single-sided reading or double-sided reading).

The CPU 51 then notifies the user of the first completion time predicted in step S107 (step S108). More specifically, the CPU 51 notifies the user of the first completion time by, for example, displaying completion time information indicating the first completion time on the display unit 18. The display unit 18 displays, as the completion time information, for example, information indicating time remaining until the reading of the document bundle is completed. The user is notified of the first completion time before reading of the certain number of document sheets is completed.

The CPU 51 may, in step S108, notify the user of the first completion time by displaying the completion time information indicating the first completion time on a user terminal (a personal computer, a mobile terminal, etc.) in addition to, or instead of, the notification with the display unit 18.

The CPU 51 then determines whether the estimated number of document sheets obtained immediately before this step exceeds the certain number of document sheets (step S109).

The “estimated number of document sheets obtained immediately before this step” refers to, when step S109 is performed for a first time, the estimated number of document sheets obtained in step S106 and, when step S109 is performed for a second time or later, the estimated number of document sheets obtained in step S112, which will be described later.

If determining that the estimated number of document sheets exceeds the certain number of document sheets (YES in step S109), the CPU 51 proceeds to step S110, and if determining that the estimated number of document sheets is smaller than or equal to the certain number of document sheets (NO in step S109), the CPU 51 ends the prediction process.

In step S110, the CPU 51 determines whether the reading unit 14 has finished reading the certain number of document sheets. If determining that the reading unit 14 has finished reading the certain number of document sheets (YES in step S110), the CPU 51 proceeds to step S111, and if determining that the reading unit 14 has not finished reading the certain number of document sheets (NO in step S110), the CPU 51 repeats step S110. That is, the CPU 51 repeats step S110 until the reading unit 14 finishes reading the certain number of document sheets, and, if determining that the reading unit 14 has finished reading the certain number of document sheets (YES in step S110), proceeds to step S111.

The “reading of the certain number of document sheets” in step S110 is, when step S110 is performed for the first time, reading of the certain number of document sheets performed for the document bundle before the reading and, when step S110 is performed for the second time or later, reading of the certain number of document sheets performed for the document bundle from which the certain number of document sheets have been read in a previous round.

In step S111, the CPU 51 obtains document bundle information indicating the weight of the document bundle after the certain number of document sheets are read. That is, the CPU 51 obtains, when the CPU 51 performs step S111 for the first time, document bundle information indicating the weight of the document bundle after the certain number of document sheets are reduced from the document bundle before the reading and, when the CPU 51 performs step S111 for the second time or later, document bundle information indicating the weight of the document bundle after the certain number of document sheets are reduced from the document bundle in a state where previous reading of the certain number of document sheets has been completed.

The CPU 51 then estimates, after the certain number of document sheets are read, the number of document sheets included in the document bundle on the basis of the amount of change in the weight of the document bundle, relationship information indicating a relationship between the amount of change and the number of document sheets read (i.e., the certain number of document sheets) and the document bundle information (step S112).

More specifically, in step S112, the CPU 51 calculates the amount of change in the weight of the document bundle on the basis of a difference between the weight of the document bundle before the certain number of document sheets are read and the weight of the document bundle after the certain number of document sheets are read. The CPU 51 then calculates the weight per document sheet as “the amount of change in the weight of the document bundle divided by the certain number of document sheets”. The CPU 51 then calculates the number of document sheets included in the document bundle before the reading as “the weight of the document bundle after the certain number of document sheets are read divided by the weight per document sheet”.

In step S112, the CPU 51 identifies the calculated weight per document sheet as a type of document sheet included in the document bundle after the certain number of document sheets are read and holds information indicating the identified type of document sheet as part of the past use information regarding the user. The information regarding the type of document sheet, therefore, will be available as the past use information regarding the user when the prediction process is performed again. The CPU 51 may identify the weight of paper in grams per 1 square meter and the size (area) of each document sheet as a type of document sheet included in the document bundle after the certain number of document sheets are read and hold information regarding the identified type of document sheet as part of the past use information regarding the user.

The CPU 51 then performs the second prediction process for predicting, after the certain number of document sheets are read, the second completion time, at which the reading of the document bundle will be completed, on the basis of the number of document sheets estimated in step S112 (hereinafter referred to as an “estimated number of document sheets”) (step S113). More specifically, the CPU 51 predicts the second completion time as “time taken to read each document sheet x the estimated number of document sheets”.

The time taken to read each document sheet can be obtained on the basis of the performance of the reading unit 14 (e.g., document conveying speed), the reading settings made by the user (e.g., resolution and single-sided reading or double-sided reading), and the like.

Next, the CPU 51 notifies the user of the second completion time predicted in step S113 (step S114) and proceeds to step S109. More specifically, the CPU 51 notifies the user of the second completion time by, for example, displaying completion time information indicating the second completion time on the display unit 18. The display unit 18 displays, as the completion time information, for example, information indicating time taken to complete the reading of the document bundle after the certain number of document sheets are read.

In step S114, the CPU 51 also notifies the user of the second completion time by displaying the completion time information indicating the second completion time on the user terminal (the personal computer, the mobile terminal, etc.).

### Effects Produced by Present Exemplary Embodiment

In the present exemplary embodiment, the CPU 51 performs the first prediction process for predicting, before the reading, the first completion time, at which reading of a bundle of document will be completed (step S107), and then performs the second prediction process for predicting, after the certain number of document sheets are read, the second completion time, at which reading of the document bundle will be completed, on the basis of the number of document sheets estimated in step S112 (step S113).

When only a prediction process for predicting a completion time, at which reading of a document bundle will be completed, is performed before the reading (hereinafter referred to as a “mode A”), the completion time needs to be predicted on the basis of information obtained before the reading of the document bundle. When the number of document sheets included in a document bundle is estimated on the basis of the weight or thickness of the document bundle before reading and a completion time is predicted on the basis of the estimated number of document sheets, for example, the predicted completion time might greatly differ from an actual completion time if the estimated number of document sheets is different from the actual number of document sheets.

In the present exemplary embodiment, on the other hand, the CPU 51 performs the first prediction process (step S107) and then performs, on the basis of the number of document sheets estimated in step S112, the second prediction process for predicting the second completion time, at which reading of a document bundle will be completed, after a certain number of document sheets are read (step S113). Accuracy of predicting a completion time, therefore, improves, compared to in the mode A.

In addition, in the present exemplary embodiment, the CPU 51 estimates, before reading of a document bundle, the number of document sheets included in the document bundle on the basis of document bundle information indicating the weight of the document bundle and performs the first prediction process for predicting the first completion time on the basis of the estimated number of document sheets (step S107).

Accuracy of predicting the first completion time, therefore, improves compared to when the number of document sheets included in a document bundle is estimated before reading of the document bundle only on the basis of results of reading of document sheets performed in the past.

In addition, in the present exemplary embodiment, if past use information regarding a user is obtained (YES in step S101), the CPU 51 identifies, on the basis of the past use information, a most frequently used type of document sheet (step S103) and estimates, on the basis of the type of document sheet and the document bundle information, the number of document sheets included in a document bundle before the reading (step S106).

The accuracy of predicting the first completion time, therefore, improves compared to when the number of document sheets included in a document bundle before reading of the document bundle is invariably estimated on the basis of a predetermined type of document sheet and document bundle information.

In addition, in the present exemplary embodiment, if past use information regarding a user is not available (NO in step S101), the CPU 51 estimates, on the basis of a predetermined type of document sheet and document bundle information, the number of document sheets included in a document bundle before reading of the document bundle.

Even if past use information regarding a user is not obtained, therefore, the first prediction process can be performed.

In addition, in the present exemplary embodiment, the CPU 51 identifies, on the basis of the amount of change in the weight of a document bundle after a certain number of document sheets are read and relationship information indicating a relationship between the amount of change and the number of document sheets read by this time (i.e., the certain number of document sheets), a type of document sheet included in the document bundle and holds information indicating the identified type of document sheet as past use information regarding a user.

The CPU 51, therefore, can use information indicating the type of document sheet identified on the basis of the relationship information as the past use information regarding the user.

In addition, in the present exemplary embodiment, the CPU 51 notifies the user of the first completion time (step S108) after the first prediction process before a certain number of document sheets are read and then notifies the user of the second completion time (step S114) after performing the second prediction process.

Opportunities for a user to know a completion time, therefore, increases compared to when the user is notified of only the first completion time or the second completion time.

In addition, in the present exemplary embodiment, the CPU 51 notifies a user terminal of the second completion time (step S114). Even when a user is away from the reading unit 14, therefore, the user can easily know the second completion time compared to when the display unit 18 provided for the reading unit 14, which reads document sheets, just displays the second completion time.

### Modifications

Although the CPU 51 estimates, before reading of a document bundle, the number of document sheets included in the document bundle on the basis of document bundle information indicating the weight of the document bundle and performs the first prediction process for predicting the first completion time on the basis of the estimated number of document sheets in the present exemplary embodiment, a method for estimating the number of document sheets is not limited to this. For example, the CPU 51 may estimate the number of document sheets included in a document bundle before reading of the document bundle only on the basis of results of reading of document sheets performed in the past, instead.

The CPU 51 may estimate the number of document sheets included in a document bundle before reading of the document bundle on the basis of document bundle information indicating the thickness of the bundle of document instead of, or in addition to, the weight of the document bundle. In this case, the reading system 10 includes a detection unit that detects the thickness of a document bundle stored in the document storage unit 12. The detection unit may detect the thickness, for example, on the basis of a dimension from the stacking surface on which the document bundle is stacked to a top document sheet of the document bundle stored in the document storage unit 12 using a sensor (e.g., an optical sensor) that detects the top document.

The CPU 51 may estimate the number of document sheets included in a document bundle before reading of the document bundle by averaging the number of document sheets estimated on the basis of the weight of the document bundle and the number of document sheets estimated on the basis of the thickness of the document bundle, instead.

Although, if past use information regarding a user is obtained, the CPU 51 identifies a most frequently used type of document sheet on the basis of the past use information and estimates, on the basis of the type of document sheet and document bundle information, the number of document sheets included in a document bundle before reading of the document bundle in the present exemplary embodiment, a method for estimating the number of document sheets is not limited to this. For example, the CPU 51 may invariably estimate the number of document sheets included in a document bundle before reading of the document bundle on the basis of a predetermined type of document sheet and document bundle information, instead.

Although the CPU 51 notifies the user terminal of the second completion time in the present exemplary embodiment, a notification method is not limited to this. For example, the CPU 51 may notify the notification unit (e.g., the display unit 18) provided for the reading unit, which reads document sheets, of the second completion time, instead.

Although the CPU 51 predicts, after a certain number of document sheets are read, the number of document sheets included in a document bundle on the basis of the amount of change in the weight of the document bundle and relationship information indicating a relationship between the amount of change and the number of document sheets read by this time (i.e., the certain number of document sheets) and document bundle information, a method for estimating the number of document sheets is not limited to this. For example, the CPU 51 may estimate, after a certain number of document sheets are read, the number of document sheets included in a document bundle on the basis of the amount of change in the thickness of the bundle of document and relationship information indicating a relationship between the amount of change and the number of document sheets read by this time (the certain number of document sheets) and document bundle information instead of, or in addition to, the amount of change in the weight of the document bundle. In this case, too, the CPU 51 may estimate the number of document sheets included in a document bundle by averaging the number of document sheets estimated on the basis of the weight of the document bundle and the number of document sheets estimated on the basis of the thickness of the document bundle, instead.

The CPU 51 may read document sheets until a document bundle loses a predetermined weight or thickness and, after a certain number of document sheets are read, estimate the number of document sheets included in the document bundle on the basis of relationship information indicating a relationship between the amount of change and the number of document sheets read by this time and document bundle information, instead.

Although the CPU 51 performs the second prediction process for estimating, after a certain number of document sheets are read, the second completion time, at which reading of a document bundle will be completed, on the basis of the estimated number of document sheets in the present exemplary embodiment, a method for predicting the second completion time is not limited to this. For example, the CPU 51 may predict, after some of the document sheets are read, the second completion time, at which reading of a document bundle will be completed, on the basis of the amount of change in the weight or thickness of the document bundle and relationship information indicating a relationship between the amount of change and time taken to read the some of the document sheets, without estimating the number of document sheets included in the document bundle, instead.

The present disclosure is not limited to the above exemplary embodiment and may be modified, altered, or improved in various ways without deviating from the scope thereof. The above-described modifications, for example, may be selectively combined together as necessary.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A prediction system including:
a processor configured to:
   perform a first prediction process for predicting a first completion time, at which reading of a document bundle will be completed, before the reading; and
   perform a second prediction process for predicting, after some of the document sheets are read, a second completion time, at which reading of the document bundle will be completed, on a basis of an amount of change in weight or thickness of the document bundle and relationship information indicating a relationship between the amount of change and a number of document sheets read by this time or time taken to read the some of the document sheets.
      (((2)))

The prediction system according to (((1))),
in which the processor is configured to predict a number of document sheets included in the document bundle before the reading on a basis of document bundle information indicating the weight or the thickness of the document bundle, and
in which the processor is configured to perform the first prediction process for predicting the first completion time on a basis of the estimated number of document sheets.
   (((3)))

The prediction system according to (((2))),
in which the processor is configured to identify, if past use information regarding a user is obtained, a most frequently used type of document sheet on a basis of the past use information, and
in which the processor is configured to estimate, on a basis of the type of document sheet and the document bundle information, the number of document sheets included in the document bundle before the reading.
   (((4)))

The prediction system according to (((3))),
in which the processor is configured to estimate, if the past use information is not obtained, the number of document sheets included in the document bundle before the reading on a basis of a predetermined type of document sheet and the document bundle information.
   (((5)))

The prediction system according to (((3))) or (((4))),
in which the processor is configured to identify, on a basis of the relationship information indicating the relationship between the amount of change and the number of document sheets read, the type of document included in the document bundle after the some of the document sheets are read, and
in which the processor is configured to hold information indicating the identified type of document sheet as part of the past use information.
   (((6)))

The prediction system according to any one of (((1))) to (((5))),
in which the processor is configured to notify a user of the first completion time after the first prediction process before the reading of the some of the document sheets is completed, and
in which the processor is configured to notify the user of the second completion time after performing the second prediction process.
   (((7)))

The prediction system according to (((6))),
in which the processor is configured to notify a user terminal of at least the second completion time.
   (((8)))

A reading system including:
a reading unit that reads each of document sheets included in a document bundle; and
the prediction system according to any one of (((1))) to (((7))) that performs the first prediction process and the second prediction process for the document bundle.
   (((9)))

A program causing a computer to execute a prediction process including:
performing a first prediction process for predicting a first completion time, at which reading of a document bundle will be completed, before the reading; and
performing a second prediction process for predicting, some of the document sheets are read, a second completion time, at which reading of the document bundle will be completed, on a basis of an amount of change in weight or thickness of the document bundle and relationship information indicating a relationship between the amount of change and a number of document sheets read by this time or time taken to read the some of the document sheets.

What is claimed is:

1. A prediction system comprising:
a processor configured to:
perform a first prediction process for predicting a first completion time, at which reading of a document bundle will be completed, before the reading; and
perform a second prediction process for predicting, after some of the document sheets are read, a second completion time, at which reading of the document bundle will be completed, on a basis of an amount of change in weight or thickness of the document bundle and relationship information indicating a relationship between the amount of change and a number of document sheets read by this time or time taken to read the some of the document sheets.

2. The prediction system according to claim 1,
wherein the processor is configured to predict a number of document sheets included in the document bundle before the reading on a basis of document bundle information indicating the weight or the thickness of the document bundle, and
wherein the processor is configured to perform the first prediction process for predicting the first completion time on a basis of the estimated number of document sheets.

3. The prediction system according to claim 2,
wherein the processor is configured to identify, if past use information regarding a user is obtained, a most frequently used type of document sheet on a basis of the past use information, and
wherein the processor is configured to estimate, on a basis of the type of document sheet and the document bundle information, the number of document sheets included in the document bundle before the reading.

4. The prediction system according to claim 3,
wherein the processor is configured to estimate, if the past use information is not obtained, the number of document sheets included in the document bundle before the reading on a basis of a predetermined type of document sheet and the document bundle information.

5. The prediction system according to claim 3,
wherein the processor is configured to identify, on a basis of the relationship information indicating the relationship between the amount of change and the number of document sheets read, the type of document sheet included in the document bundle after the some of the document sheets are read, and
wherein the processor is configured to hold information indicating the identified type of document sheet as part of the past use information.

6. The prediction system according to claim 1,
wherein the processor is configured to notify a user of the first completion time after the first prediction process before the reading of the some of the document sheets is completed, and
wherein the processor is configured to notify the user of the second completion time after performing the second prediction process.

7. The prediction system according to claim 6,
wherein the processor is configured to notify a user terminal of at least the second completion time.

8. A reading system comprising:
a reading unit that reads each of document sheets included in a document bundle; and
the prediction system according to claim 1 that performs the first prediction process and the second prediction process for the document bundle.

9. A reading system comprising:
a reading unit that reads each of document sheets included in a document bundle; and
the prediction system according to claim 2 that performs the first prediction process and the second prediction process for the document bundle.

10. A reading system comprising:
a reading unit that reads each of document sheets included in a document bundle; and
the prediction system according to claim 3 that performs the first prediction process and the second prediction process for the document bundle.

11. A reading system comprising:
a reading unit that reads each of document sheets included in a document bundle; and
the prediction system according to claim 4 that performs the first prediction process and the second prediction process for the document bundle.

12. A reading system comprising:
a reading unit that reads each of document sheets included in a document bundle; and
the prediction system according to claim 5 that performs the first prediction process and the second prediction process for the document bundle.

13. A reading system comprising:
a reading unit that reads each of document sheets included in a document bundle; and
the prediction system according to claim 6 that performs the first prediction process and the second prediction process for the document bundle.

14. A reading system comprising:
a reading unit that reads each of document sheets included in a document bundle; and
the prediction system according to claim 7 that performs the first prediction process and the second prediction process for the document bundle.

15. A non-transitory computer readable medium storing a program causing a computer to execute a process for prediction, the process comprising:
performing a first prediction process for predicting a first completion time, at which reading of a document bundle will be completed, before the reading; and
performing a second prediction process for predicting, after some of the document sheets are read, a second completion time, at which reading of the document bundle will be completed, on a basis of an amount of change in weight or thickness of the document bundle and relationship information indicating a relationship between the amount of change and a number of document sheets read by this time or time taken to read the some of the document sheets.

16. A method comprising:
performing a first prediction process for predicting a first completion time, at which reading of a document bundle will be completed, before the reading; and
performing a second prediction process for predicting, after some of the document sheets are read, a second completion time, at which reading of the document bundle will be completed, on a basis of an amount of change in weight or thickness of the document bundle and relationship information indicating a relationship between the amount of change and a number of document sheets read by this time or time taken to read the some of the document sheets.
